(19) United States
(12) Patent Application Publication
(10) Pub. No.: US 2022/0144416 A1
(43) Pub. Date: May 12, 2022

(54) LIQUID INERTIA VIBRATION ELIMINATION SYSTEM WITH COMPOUND PERIOD STRUT

(71) Applicant: Bell Textron Inc., Fort Worth, TX (US)

(72) Inventor: Peter Quinn Romano, Fort Worth, TX (US)

(73) Assignee: Bell Textron Inc., Fort Worth, TX (US)

(21) Appl. No.: 17/092,296

(22) Filed: Nov. 8, 2020

(51) Int. Cl. B64C 27/00; F16F 15/027; F16F 7/10

(52) U.S. Cl. CPC B64C 27/001; F16F 15/0275; F16F 7/1034; B64C 2027/004; F16F 2228/001; F16F 2228/066; F16F 2232/02; F16F 2222/08

(57) ABSTRACT

A liquid inertia vibration elimination (“LIVE”) system for a rotor system having n number of blades. The LIVE system includes a first tuned vibration reduction component configured to provide a maximum vibratory isolation at a frequency below 2*n/rev and a second tuned vibration reduction component configured to provide a maximum vibratory isolation at a frequency above 3*n/rev.

### BACKGROUND

The present disclosure relates in general to vibration control. More specifically, the present disclosure relates to a novel design of an apparatus for isolating mechanical vibrations in structures or bodies that are subject to harmonic or oscillating displacements or forces over a wide range of frequencies. The apparatus of the present disclosure is well suited for use in the field of aircraft, in particular, helicopters and other rotary wing aircraft.

For many years, effort has been directed toward the design of an apparatus for isolating a vibrating body from transmitting its vibrations to another body. Such apparatuses are useful in a variety of technical fields in which it is desirable to isolate the vibration of an oscillating or vibrating device, such as an engine, from the remainder of the structure. Typical vibration isolation and attenuation devices (“isolators”) employ various combinations of the mechanical system elements (springs and mass) to adjust the frequency response characteristics of the overall system to achieve acceptable levels of vibration in the structures of interest in the system. One field in which these isolators find a great deal of use is in aircraft, wherein vibration-isolation systems are utilized to isolate the fuselage or other portions of an aircraft from mechanical vibrations, such as harmonic vibrations, which are associated with the propulsion system, and which arise from the engine, transmission, and propellers or rotors of the aircraft.

Vibration isolators are distinguishable from damping devices in the prior art that are erroneously referred to as “isolators.” A simple force equation for vibration is set forth as follows:

F=m\ddot{x}+c\dot{x}+kx

A vibration isolator utilizes inertial forces (m\ddot{x}) to cancel elastic forces (kx). On the other hand, a damping device is concerned with utilizing dissipative effects (c\dot{x}) to remove energy from a vibrating system.

One important engineering objective during the design of an aircraft vibration-isolation system is to minimize the length, weight, and overall size including cross-section of the isolation device. This is a primary objective of all engineering efforts relating to aircraft. It is especially important in the design and manufacture of helicopters and other rotary wing aircraft, such as tilt rotor aircraft, which are required to hover against the dead weight of the aircraft, and which are, thus, somewhat constrained in their payload in comparison with fixed-wing aircraft.

Another important engineering objective during the design of vibration-isolation systems is the conservation of the engineering resources that have been expended in the design of other aspects of the aircraft or in the vibration-isolation system. In other words, it is an important industry objective to make incremental improvements in the performance of vibration isolation systems which do not require radical re-engineering or complete redesign of all the components which are present in the existing vibration-isolation systems.

A marked departure in the field of vibration isolation, particularly as applied to aircraft and helicopters is disclosed in U.S. Pat. No. 4,236,607, titled “Vibration Suppression System,” issued on Dec. 2, 1980, to Halwes, et al. (“Halwes '607”). Halwes '607 is incorporated herein by reference. Halwes '607 discloses a vibration isolator, in which a dense, low-viscosity fluid is used as the “tuning” mass to counterbalance, or cancel, oscillating forces transmitted through the isolator. This isolator employs the principle that the acceleration of an oscillating mass is 180° out of phase with its displacement.

In Halwes '607, it was recognized that the inertial characteristics of a dense, low-viscosity fluid, combined with a hydraulic advantage resulting from a piston arrangement, could harness the out-of-phase acceleration to generate counter-balancing forces to attenuate or cancel vibration. Halwes '607 provided a much more compact, reliable, and efficient isolator than was provided in the prior art. The original dense, low-viscosity fluid contemplated by Halwes '607 was mercury, which is toxic and highly corrosive.

Since Halwes' early invention, much of the effort in this area has been directed toward replacing mercury as a fluid or to varying the dynamic response of a single isolator to attenuate differing vibration modes. An example of the latter is found in U.S. Pat. No. 5,439,082, titled “Hydraulic Inertial Vibration Isolator,” issued on Aug. 8, 1995, to McKeown, et al. (“McKeown '082”). McKeown '082 is incorporated herein by reference. An example of the former is found in U.S. Pat. No. 6,022,600, titled “High-Temperature Fluid Mounting”, issued on Feb. 8, 2000, to Schmidt et al. (“Schmidt '600”). Schmidt '600 is incorporated herein by reference.

Several factors affect the performance and characteristics of the Halwes-type isolator, including the density and viscosity of the fluid employed, the relative dimensions of components of the isolator, and the like. One improvement in the design of such isolators is disclosed in U.S. Pat. No. 6,009,983, titled “Method and Apparatus for Improved Vibration Isolation,” issued on Jan. 4, 2000, to Stamps et al. (“Stamps '983”). In Stamps '983, a compound radius at each end of the tuning port was employed to provide a marked improvement in the performance of the isolator. Stamps '983 is incorporated herein by reference.

Another area of improvement in the design of the Halwes-type isolator has been in an effort directed toward a means for changing the isolator's frequency in order to increase the isolator's effectiveness during operation. One development in the design of such isolators is disclosed in U.S. Pat. No. 5,435,531, titled “Vibration Isolation System,” issued on Jul. 25, 1995, to Smith et al. (“Smith '531”). Smith '531 is incorporated herein by reference. In Smith '531, an axially extendable sleeve is used in the inner wall of the tuning port in order to change the length of the tuning port, thereby changing the isolation frequency. Another development in the design of tunable Halwes-type isolators was disclosed in U.S. Pat. No. 5,704,596, titled “Vibration Isolation System,” issued on Jan. 6, 1998, to Smith et al. (“Smith '596”). Smith '596 is incorporated herein by reference. In Smith '596, a sleeve is used in the inner wall of the tuning port in order to change the cross-sectional area of the tuning port itself, thereby changing the isolation frequency during operation. Both Smith '531 and Smith '596 were notable attempts to actively tune the isolator.

Another development in the area of vibration isolation is the tunable vibration isolator disclosed in U.S. Pat. No. 6,695,106, titled “Method and Apparatus for Improved Vibration Isolation,” issued on Feb. 24, 2004, to Smith et al (“Smith '106”). Smith '106 is incorporated herein by reference.

An additional development in the area of vibration isolation is the external tuning port disclosed in U.S. patent application Ser. No. 15/240,797, titled “Liquid Inertia Vibration Elimination System,” filed on Aug. 18, 2016, which is incorporated herein by reference. Although the foregoing developments represent great strides in the area of vibration isolation, a need for systems capable of reducing vibrations of significantly higher frequencies than the above-described vibration reduction systems remains.

### BRIEF DESCRIPTION OF THE DRAWINGS

FIG. 1 is a side view of a helicopter including a liquid inertia vibration elimination (“LIVE”) system according to an embodiment of this disclosure.

FIG. 2 is an oblique view of a portion of the helicopter of FIG. 1 showing the LIVE system.

FIG. 3 is an oblique view of a portion of the helicopter of FIG. 1 showing the LIVE system in greater detail.

FIG. 4 is a side view of the LIVE systems of FIGS. 1-3.

FIG. 5 is a cross-sectional side view of the LIVE system of FIGS. 1-4.

Prior Art FIG. 6 is a graph of a frequency response of a prior art LIVE system.

FIG. 7 is a graph of a frequency response of the LIVE system of FIGS. 1-4.

FIG. 8 is a side view of a LIVE system supported by compound period struts according to another embodiment of this disclosure.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. In addition, the use of the term “coupled” throughout this disclosure may mean directly or indirectly connected, moreover, “coupled” may also mean permanently or removably connected, unless otherwise stated.

This disclosure provides a liquid inertia vibration elimination (“LIVE”) system having a compound periodic strut configured to reduce vibrations of much greater frequency as compared to a tuned frequency of a traditional LIVE system. The compound period strut is made possible by the systems and methods disclosed in (1) Chinese Patent No. 104408488, titled “Compound Helicopter Main Reducing Period Support Rod,” issued on Dec. 8, 2017 to UNIV NANJING AERONAUTICS & ASTRONAUTICS (Chinese Patent '488), (2) Wang, F., Lu, Y. and Li, J., “Helicopter Cabin Noise Reduction Based on Compound Period Struts,” American Helicopter Society 74^{th} Annual Forum Proceedings, Phoenix, Ariz., USA, May 14-17, 2018 (AHS Wang/Lu/Li), and (3) Lu, Y., Wang, F., and Ma, X., “Research on the Vibration Characteristics of a Compounded Periodic Strut Used for Helicopter Cabin Noise Reduction,” Shock and Vibration, Vol. 2017, Article ID 4895026, http://doi.org/10.1155/2017/4894026 (Shock and Vibration Lu/Wang/Ma). Chinese Patent '488, AHS Wang/Lu/Li, and Shock and Vibration Lu/Wang/Ma are each incorporated herein by reference.

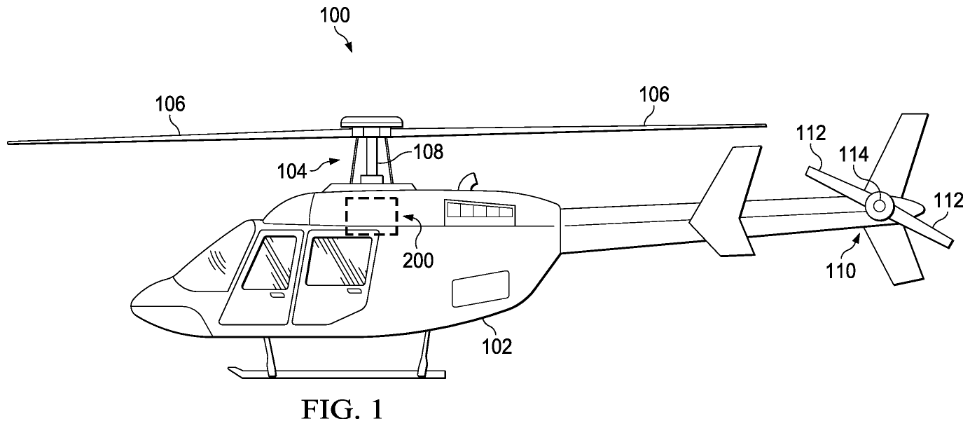

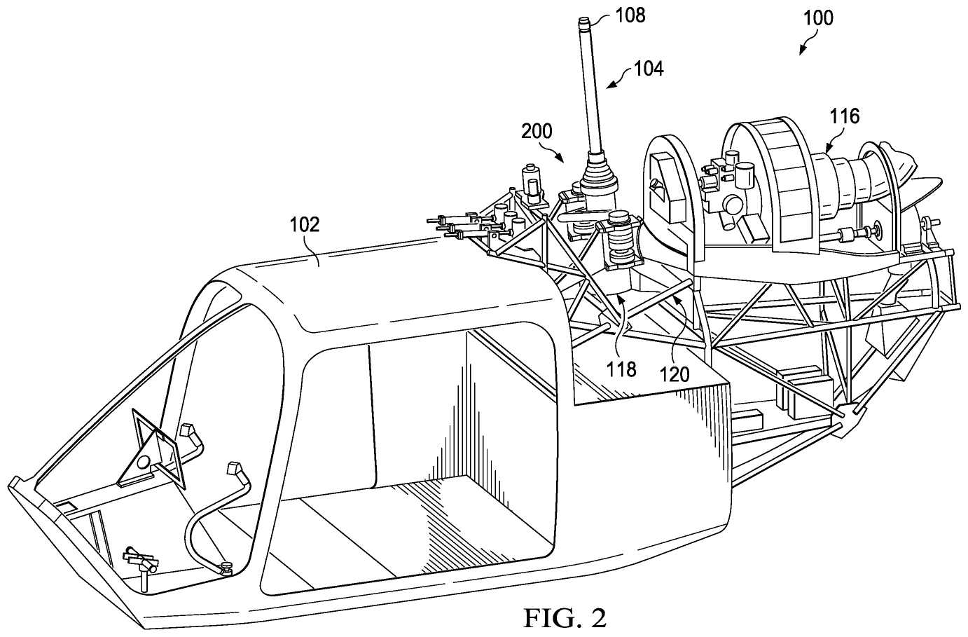

Referring now to FIGS. 1 and 2 in the drawings, a helicopter 100 according to the present disclosure is illustrated. Helicopter 100 comprises a fuselage 102 and a main rotor assembly 104, including main rotor blades 106 and a main rotor shaft 108. Helicopter 100 comprises a tail rotor assembly 110, including tail rotor blades 112 and a tail rotor shaft 114. Main rotor blades 106 generally rotate about a vertical axis of main rotor shaft 108. Tail rotor blades 112 generally rotate about a lateral axis of tail rotor shaft 114. Helicopter 100 further comprises two LIVE systems 200 according to the present disclosure for isolating fuselage 102 or other portions of helicopter 100 from mechanical vibrations, such as harmonic vibrations, which are associated with the propulsion system and which can arise from an engine 116, transmission 118, and rotor assemblies 104, 110 of helicopter 100.

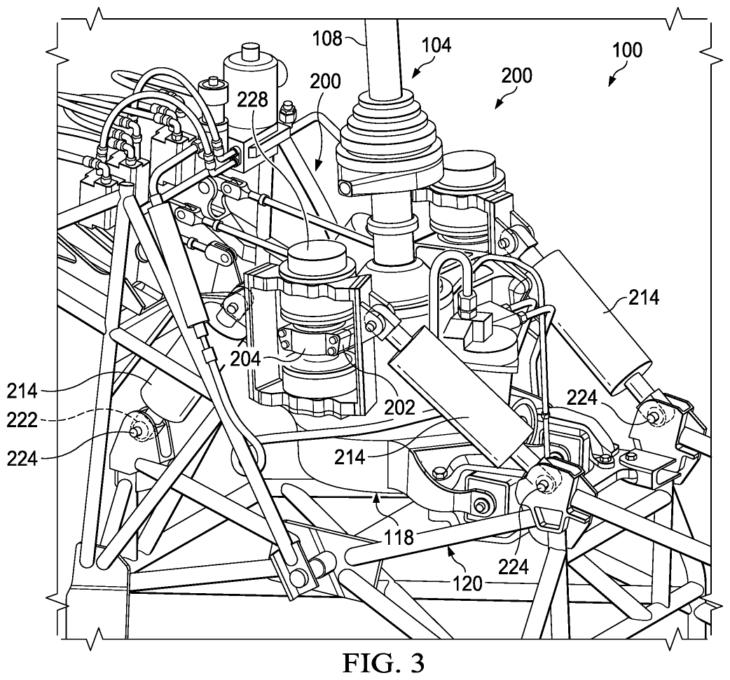

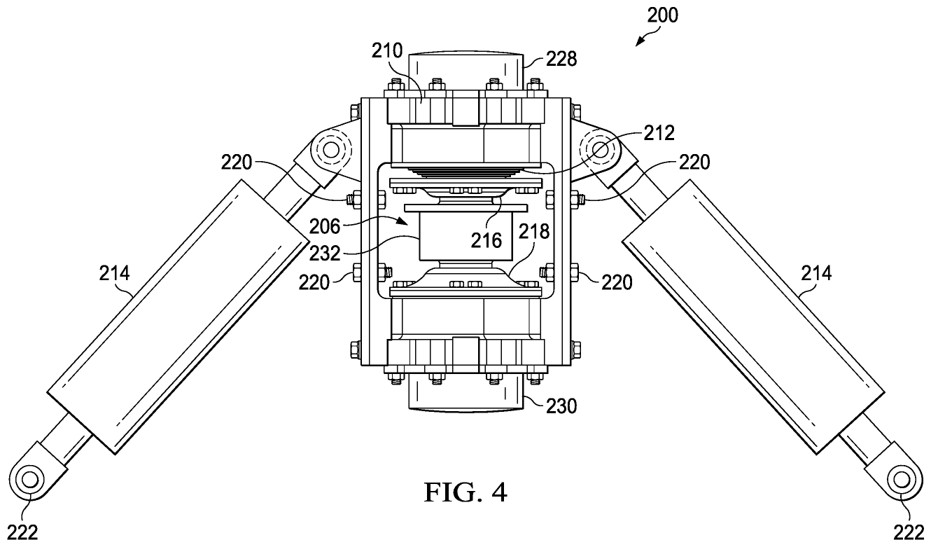

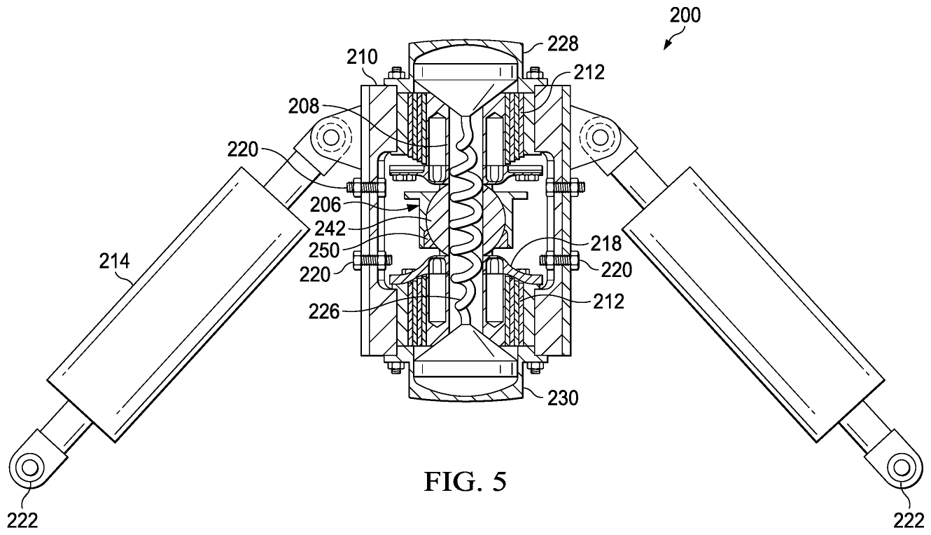

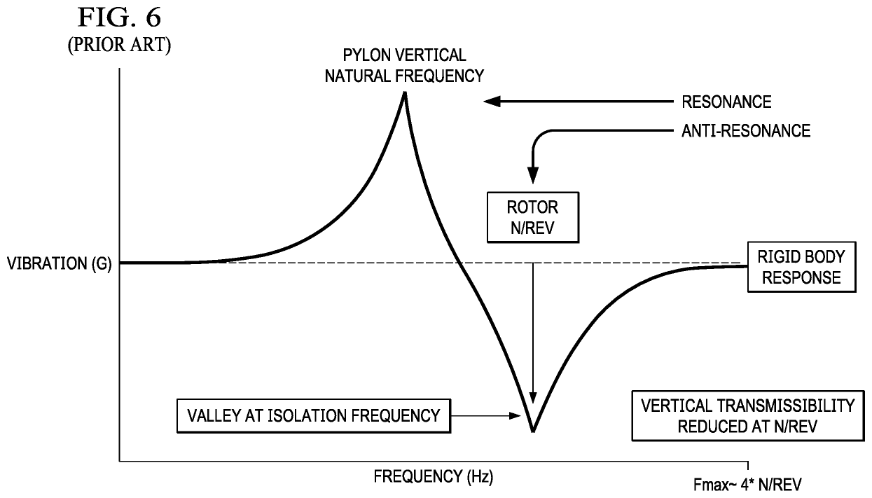

Referring to FIGS. 3-5, transmission 118 is suspended by two LIVE systems 200 that connect to an internal frame 120 of helicopter 100. More specifically, a bridge beam 202 and a complementary bridge cap 204 of each LIVE system 200 are used to capture and connect a spherical center bearing 206 of LIVE system 200 to transmission 118. Spherical center bearing 206 generally receives a piston 208 through a central passage of spherical center bearing 206 (see FIG. 5). LIVE system 200 is further connected to internal frame 120 using a three-piece assembly comprising a central bearing housing 210 configured to receive two journal bearings 212 and two struts 214. Spherical center bearing 206 provides pitch compliance for transmission 118 while journal bearings 212 provide vertical compliance. Vertical travel is limited in an upward direction by a shimmable up-stop 216 and limited in a downward direction by a shimmable down-stop 218.

Struts 214 are attached to central bearing housing 210 using fasteners 220, which in this embodiment comprise bolts. Struts 214 are further attached to trusses of internal frame 120 using spherical truss attachment bearings 222 and pins 224. Struts 214 can transfer thrust and torque loads to internal frame 120. Spherical truss attachment bearings 222 allow for moment alleviation and dynamic tuning.

During operation of LIVE systems 200, the introduction of a force into piston 208 translates piston 208 relative to upper end cap 228 and lower end cap 230. Such a displacement of piston 208 forces tuning fluid that is disposed within the fluid flow path to move through central port 226 in the opposite direction of the displacement of piston 208. Such a movement of tuning fluid produces an inertial force that cancels, or isolates, the force from piston 208. During typical operation, the force imparted on piston 208 is oscillatory; therefore, the inertial force of the tuning fluid is also oscillatory, the oscillation being at a discrete frequency, i.e., isolation frequency.

Referring now to Prior Art FIG. 6, a graph of frequency response of a prior art LIVE system substantially similar to LIVE system 200, but without struts 214, is shown. The prior art LIVE systems that do not incorporate compound periodic struts such as struts 214 essentially add vertical compliance to connection between the rotor system and the fuselage, thereby introducing resonance and anti-resonance. The resonance is associated with the pylon natural frequency while the anti-resonance is tunable insofar as it is either selected as a constant during design of the LIVE system or in active LIVE systems, can be changed during operation of the LIVE system. As shown, the prior art LIVE system can provide a drastic reduction in vibratory response at a chosen isolation frequency that is selected as a function the blade pass frequency, n/rev, where n is the number of blades of the rotor system. However, as shown in the graph, as the frequency of an input is increased upward from the selected isolation frequency, the LIVE system increasingly reacts with less isolation effect and more of a rigid body response until at 2*n/rev, the response is essentially a rigid body response. In other words, while the prior art LIVE systems are effective at isolation about a selected low frequency input, the prior art LIVE systems do not offer any substantial benefit for input frequencies above 2*n/rev.

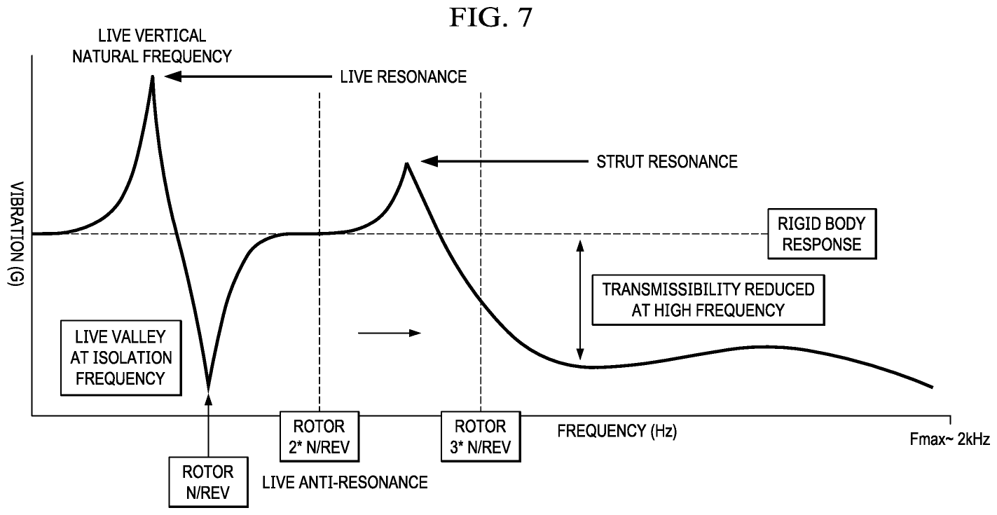

Referring now to FIG. 7, a graph of frequency response of the LIVE system 200 is shown. The primary difference between the prior art LIVE system and LIVE system 200 is that LIVE system 200 further comprises at least one strut 214 that is configured to reduce vibration attributable to inputs having frequencies above 2*n/rev. Although adding the struts 214 into the LIVE system does introduce an undesirable strut resonance that resides between 2*n/rev and 3*n/rev, significant reductions in transmissibility can be achieved at input frequencies approaching 3*n/rev and between 3*n/rev and about 2 kHz. In essence, the addition of the struts 214 offer an improved vibration reduction at a selected band of frequencies above which a prior art LIVE system would generally respond as a rigid body. The addition of the struts 214 can reduce cabin noise such as noise attributable gear mesh frequency noise. Furthermore, a stiffness of the struts 214 can be tuned to place the strut resonance away from rotor harmonics. The struts 214 can comprise, for example, but not limited to, a compound periodic strut as disclosed in one or more of Chinese Patent '488, AHS Wang/Lu/Li, and Shock and Vibration Lu/Wang/Ma.

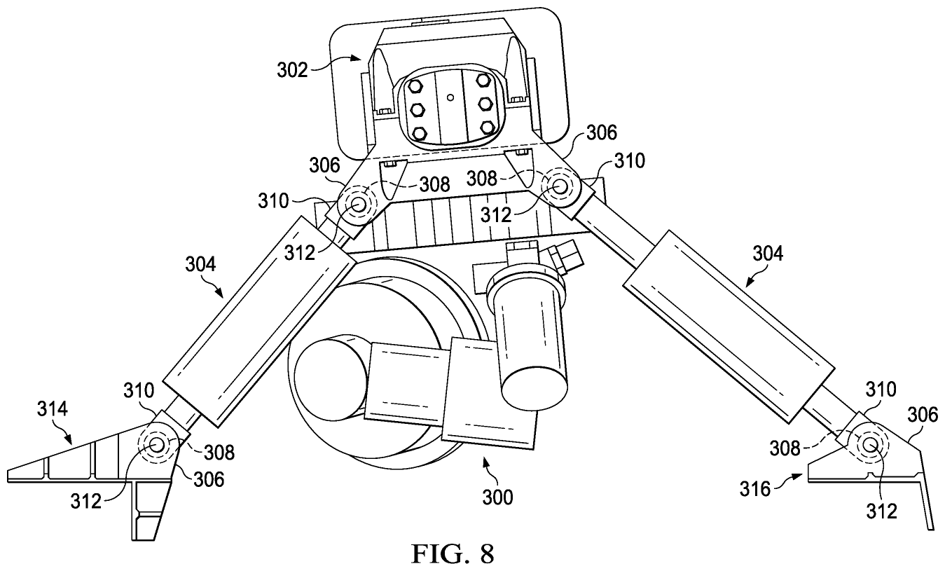

Referring to FIG. 8, an alternative embodiment of a compound period strut supported LIVE system is disclosed. In this embodiment, a transmission 300 of Bell M430 helicopter is connected to a LIVE system 302 that is supported by compound period struts 304 that are substantially similar to struts 214. The LIVE system 302 comprises two sets of opposing mount tabs 306 configured for capturing the spherical bearings 308 within eyelets 310 of upper ends of struts 304. In this embodiment, pins 312 are received through spherical bearings 308 and associated apertures of mount tabs 306. Similarly, a forward fitting 314 and an aft fitting 316 comprise opposing mount tabs 306 configured for capturing the spherical bearings 308 within eyelets 310 of lower ends of struts 304. The struts 304 operate substantially similar to the operation of struts 214.

While the LIVE systems disclosed herein comprise a passive system for combating vibration at frequencies lower than 2*n/rev, in alternative embodiments, actively controlled LIVE systems may be utilized that perform an electronically controlled actuation and/or an electronically controlled tuning of the isolation frequency. Further, the frequency response of the struts can be tuned during design by changing materials, geometries, and/or sizes of the internal components of the struts as well as, in some cases, electronically controlling a material property, geometry, and/or size of one or more internal components of the struts. Further, it will be appreciated that the struts 214, 304 disclosed herein are shown schematically to demonstrate one embodiment of an interior construction.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A liquid inertia vibration elimination (“LIVE”) system for a rotor system having n number of blades, comprising:
a first tuned vibration reduction component configured to provide a maximum vibratory isolation at a frequency below 2*n/rev; and
a second tuned vibration reduction component configured to provide a maximum vibratory isolation at a frequency above 3*n/rev.

2. The LIVE system of claim 1, wherein the second tuned vibration reduction component comprises a compound periodic strut.

3. The LIVE system of claim 2, wherein the second tuned vibration reduction component is configured to be tunable during operation

4. The LIVE system of claim 1, wherein the first tuned vibration reduction component is configured to be tunable during operation.

5. The LIVE system of claim 1, wherein a resonance of the second tuned vibration reduction component is selected to not coincide with rotor harmonics.

6. The LIVE system of claim 1, wherein the first tuned vibration reduction component is coupled to a plurality of the second tuned vibration reduction components.

7. A rotorcraft, comprising:
a rotor system comprising n number of blades;
a fuselage; and
a liquid inertia vibration elimination (“LIVE”) system, comprising:
a first tuned vibration reduction component configured to provide a maximum vibratory isolation at a frequency below 2*n/rev; and
a second tuned vibration reduction component configured to provide a maximum vibratory isolation at a frequency above 3*n/rev.

8. The rotorcraft of claim 7, wherein the second tuned vibration reduction component comprises a compound periodic strut.

9. The rotorcraft of claim 8, wherein the second tuned vibration reduction component is configured to be tunable during operation

10. The rotorcraft of claim 7, wherein the first tuned vibration reduction component is configured to be tunable during operation.

11. The rotorcraft of claim 7, wherein a resonance of the second tuned vibration reduction component is selected to not coincide with rotor harmonics.

12. The rotorcraft of claim 7, wherein the first tuned vibration reduction component is coupled to a plurality of the second tuned vibration reduction components.

13. The rotorcraft of claim 7, wherein the first tuned vibration reduction component and the second tuned vibration reduction component are connected to each other in series between the rotor system and the fuselage.

14. A method of reducing vibration, comprising:
providing a rotor system comprising n number of blades;
providing an isolated component;
connecting the rotor system to the isolated component using a liquid inertia vibration elimination (“LIVE”) system, comprising:
a first tuned vibration reduction component configured to provide a maximum vibratory isolation at a frequency below 2*n/rev; and
a second tuned vibration reduction component configured to provide a maximum vibratory isolation at a frequency above 3*n/rev.

15. The method of claim 14, wherein the isolated component comprises a fuselage.

16. The method of claim 14, wherein the second tuned vibration reduction component comprises a compound periodic strut.

17. The method of claim 14, wherein the second tuned vibration reduction component is configured to be tunable during operation.

18. The method of claim 14, wherein the first tuned vibration reduction component is configured to be tunable during operation.

19. The method of claim 14, wherein a resonance of the second tuned vibration reduction component is selected to not coincide with rotor harmonics.

20. The method of claim 14, wherein the first tuned vibration reduction component is coupled to a plurality of the second tuned vibration reduction components.
